(19) United States
(12) Patent Application Publication
(10) Pub. No.: US 2023/0282401 A1
(43) Pub. Date: Sep. 7, 2023

(54) BOBBIN STRUCTURE FOR WINDING OF SUPERCONDUCTING WIRE ROD

(71) Applicant: LS ELECTRIC CO., LTD., Anyang-si, Gyeonggi-do (KR)

(72) Inventors: Min-Jee KIM, Anyang-si, Gyeonggi-do (KR); Ki-Nam YOO, Anyang-si, Gyeonggi-do (KR)

(21) Appl. No.: 18/016,586

(22) PCT Filed: Sep. 23, 2020
(86) PCT No.: PCT/KR2020/012873

§ 371 Date: Jan. 17, 2023

(30) Foreign Application Priority Data
Jul. 17, 2020 (KR) 10-2020-0088973

(51) Int. Cl. H01F 6/06; H01F 6/04

(52) U.S. Cl. CPC H01F 6/06; H01F 6/04

(57) ABSTRACT

Disclosed is a bobbin structure for winding a superconducting wired rod, which can secure a minimum radius of curvature that can prevent a deterioration in mechanical properties and a decrease in the uniformity of electromagnetic force distribution, due to contraction and expansion acting on the wire rod during quenching of the superconducting wire rod, and which also can ensure uniformity of temperature over all portions of the superconducting wire rod by securing a cooling channel required for cooling of the superconducting wire rod.

### FIELD

The present disclosure relates to a structure of a bobbin for winding a superconducting wire rod, and more specifically, to a bobbin structure for winding a superconducting wire rod capable of preventing deterioration of mechanical properties and uniformity of an electromagnetic force distribution resulted from shrinkage and expansion during quenching of the wound superconducting wire rod, and securing a cooling channel required for cooling the superconducting wire rod.

### DESCRIPTION OF RELATED ART

In general, a fault current limiter corresponds to an electric power device that, in the event of an accident in an electric power system, protects the system by rapidly reducing a fault current. The fault current limiter plays a role in minimizing a scope of blackout and reducing damage to equipment on a track.

In other words, the fault current limiter is a device that, when a large-scale fault current occurs due to the system accident in the electric power system, rapidly lowers the fault current to a value equal to or lower than an appropriate value so as to prevent mechanical, thermal, and electrical stress in the electric power device and improve reliability of the electric power system.

However, due to continuous rise of the system fault current and difficulty of developing an electric power device corresponding thereto, a demand for development of a fault current limiting element capable of controlling the fault current is rapidly increasing. However, a development of a fault current limiting technology that may be practically applied to the system is delayed due to difficulties such as technical difficulties and commercialization.

Recently, with discovery of a high-temperature superconductor, a possibility of developing a fault current limiter that applies nonlinear voltage-current characteristics of this new element has emerged, and a development of a high-temperature superconducting fault current limiter using liquid nitrogen as a refrigerant is beginning in earnest. Because a superconducting material has high nonlinear resistance characteristics, the superconducting material has a potential of being applied as the fault current limiting element. The high-temperature superconducting fault current limiter may generate high resistance using quench characteristics from a superconducting state to a normal conduction state and act as a fuse in a short time when the accident is sensed in the system to limit the fault current. In addition, the fault current limiter has characteristics of transitioning back to the superconducting state after reducing the fault current.

A superconducting fault current limiting module, which is a core part of the superconducting fault current limiter, is composed of a series or parallel combination of coils with a certain capacity in which a superconducting wire rod is wound. As the coil becomes smaller and lighter for the certain capacity, an operating efficiency of a cryogenic cooling system increases.

In addition, AC loss occurs when a normal load current is applied to the superconducting wire rod, and the AC loss is converted into heat and becomes a factor in increasing an amount of a cooling load. Therefore, in order to minimize the AC loss, a technology for winding the superconducting wire rod in a bifilar form has been developed.

In addition, the superconducting wire rods are generally wound by inserting an insulating spacer therebetween during the winding. In this case, a distance between the wire rods to which the current is applied increases and is not constant, so that the AC loss, that is, the cooling load increases. Therefore, in order to maintain insulation between the wire rods when the superconducting wire rods are wound, the wire rods are wound by wrapping an insulation tape available at cryogenic temperatures thereon to maintain the insulation.

However, when the superconducting wire rods wrapped with the insulating tape are wound without the separate spacer, a core condition of the superconducting fault current limiting element, which must maintain a constant temperature in a longitudinal direction of the wire rod, may not be satisfied. (the core condition of the superconducting fault current limiting element; a critical current of the superconductor varies with temperature, and for this reason, temperature uniformity of the superconducting wire rod is very important for simultaneous quenching at the critical current.) In particular, securing an LN2 cooling channel of a bobbin is very important in a structure where the coils are compactly stacked.

Accordingly, conventionally, a technology of, when winding the superconducting wire rod wrapped with the insulating tape in the bifilar form, winding the wire rod on an elliptical bobbin having the most compact size while satisfying a minimum radius of curvature of the wire rod was developed.

However, when winding the superconducting wire rod on the elliptical bobbin, a straight portion and a curved portion inevitably exist in the longitudinal direction of the superconducting wire rod. Such form causes deterioration of mechanical properties and uniformity of an electromagnetic force distribution resulted from shrinkage and expansion acting on the wire rod during the quenching of the superconducting wire rod, resulting in deterioration of the superconducting wire rod.

### DISCLOSURE

### Technical Purposes

The present disclosure is to provide a bobbin structure for winding a superconducting wire rod capable of securing a minimum radius of curvature for preventing deterioration of mechanical properties and uniformity of an electromagnetic force distribution resulted from shrinkage and expansion acting on the wire rod during quenching of the wound superconducting wire rod, and also ensuring temperature uniformity over an entirety of the superconducting wire rod by securing a cooling channel required for cooling the superconducting wire rod.

### Technical Solutions

According to the present disclosure to solve the above technical problems, a bobbin structure for winding a superconducting wire rod includes a base plate stacked inside a low-temperature container for storing low-temperature fluid therein, a pair of circular openings respectively defined at left and right sides of the base plate, and a pair of protruding structures respectively extending from circumferential portions of the circular openings on the left and right sides of a central portion of the base plate for the winding of the superconducting wire rod, wherein bottom surfaces of the pair of protruding structures are coupled to the base plate, and each protruding structure includes an arc-shaped first extension extending along the circumferential portion of each circular opening from a position adjacent to the central portion of the base plate, and an arc-shaped second extension extending from the first extension along another circumferential portion located radially outward of the circumferential portion of each circular opening.

According to an embodiment of the present disclosure, the first extension extends long over a phase angle of about 180 degrees along a circumferential portion of a first reference circle set by each circular opening from a starting point located adjacent to the central portion of the base plate, a connection point between the first extension and the second extension is located on another second reference circle on a concentric circle located radially outward of a center of the first reference circle set by each circular opening with respect to the central portion of the base plate, and the second extension extends long over a phase angle of about 180 degrees along a circumferential portion of the second reference circle from the connection point.

According to an embodiment of the present disclosure, an end point at a free end of a second extension of one protruding structure extends long toward a first extension of the other protruding structure located on an opposite side, and is located at a point spaced apart from the first extension of the other protruding structure by a predetermined spacing.

According to an embodiment of the present disclosure, the first extension is set to have a minimum radius of curvature capable of preventing deterioration of mechanical properties and uniformity of electromagnetic force distribution resulted from shrinkage and expansion during quenching of the superconducting wire rod, and the second extension is set to have a larger radius of curvature than the first extension.

According to an embodiment of the present disclosure, each protruding structure is constructed as a partition wall structure protruding in a vertical direction with respect to the base plate, and has concavo-convex portions having different protruding heights in the vertical direction on a top surface thereof for defining a cooling channel, and the concavo-convex portions include a plurality of concavo-convex portions as an alternating arrangement structure over a longitudinal direction of each protruding structure.

According to an embodiment of the present disclosure, each protruding structure includes a cutout over a partial section of the circumferential portion of each circular opening for defining a cooling channel.

According to an embodiment of the present disclosure, the partial section of the circumferential portion of each circular opening where the cutout is defined is located between the first extension and the second extension of each protruding structure and located on a side opposite to a formation position of the first extension with respect to a center of each circular opening.

According to an embodiment of the present disclosure, each protruding structure has a through-hole for fastening for vertical stacking of the bobbins, and the through-hole for fastening includes a plurality of through-holes for fastening along a longitudinal direction of the protruding structure.

According to an embodiment of the present disclosure, the base plate includes a plurality of through-holes defined around the circular openings for defining a cooling channel.

According to an embodiment of the present disclosure, the circular openings and the through-holes are arranged in a radial structure with respect to a center of the base plate.

### Technical Effects

An embodiment of the present disclosure may contribute to miniaturization and weight reduction of the superconducting coil because, in the bobbin for winding the superconducting wire rod, the protruding structure constituting the bobbin is able to secure the appropriate minimum radius of curvature capable of preventing the deterioration of the mechanical properties and the uniformity of the electromagnetic force distribution resulted from the shrinkage and the expansion acting on the wire rod during the quenching of the wound superconducting wire rod.

In addition, the bobbin structure for winding the superconducting wire rod according to an embodiment of the present disclosure may define the cooling channel for the flow of the cryogenic fluid using each of the cutout in the form in which the portion of the protruding structure equipped in the bobbin where the superconducting wire rod is not wound is cut, and the concavo-convex portions formed on the top surface of the protruding structure and in the form in which the portion of the protruding structure is cut such that the concavo-convex portions have different protruding heights in the vertical direction, thereby providing an appropriate cooling performance required for the superconducting wire rod.

As a result, the bobbin structure for winding the superconducting wire rod according to an embodiment of the present disclosure secures an optimal cooling efficiency for the fault current limiting module, which is the core part of the fault current limiter, thereby minimizing the cooling load.

### BRIEF DESCRIPTION OF DRAWINGS

FIG. 1 is a view showing an outer appearance of a superconducting fault current limiter to which a bobbin for winding a superconducting wire rod according to an embodiment of the present disclosure is applied.

FIG. 2 is a view showing a low-temperature container exposed to the outside in a state in which an external vacuum container is removed from a superconducting fault current limiter shown in FIG. 1.

FIG. 3 is a view showing a modular state in which a plurality of bobbins for winding a superconducting wire rod according to an embodiment of the present disclosure are stacked along a vertical direction inside a low-temperature container shown in FIG. 2.

FIG. 4 is for illustrating a bobbin structure for winding a superconducting wire rod according to an embodiment of the present disclosure, and is a perspective view separately showing only one bobbin among the stacked bobbins in the module shown in FIG. 3.

FIG. 5 is for illustrating a bobbin structure for winding a superconducting wire rod according to an embodiment of the present disclosure, and is a plan view separately showing only a base plate from a bobbin shown in FIG. 4.

FIG. 6 is for illustrating a bobbin structure for winding a superconducting wire rod according to an embodiment of the present disclosure, and is a plan view separately showing only a protruding structure from a bobbin shown in FIG. 4.

### DETAILED DESCRIPTIONS

Hereinafter, a preferred embodiment of the present disclosure will be described in detail with reference to the accompanying drawings. In this process, thicknesses of lines or sizes of components shown in the drawings may be exaggerated for clarity and convenience of illustration. In addition, terms to be described later are terms defined in consideration of functions in the present disclosure, which may vary based on the intention of a user or an operator or the custom. Therefore, definitions of such terms should be made based on the contents described herein. In addition, an embodiment below does not limit the scope of rights of the present disclosure, but is merely an example of the components presented in the claims of the present disclosure. An embodiment that is included in the technical spirit throughout the present document of the present disclosure and includes components that may be replaced as equivalents of the components of the claims may be included in the scope of rights of the present disclosure.

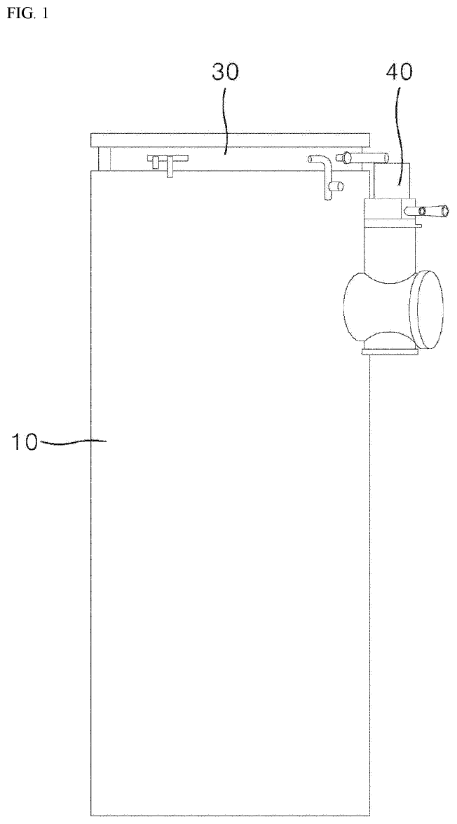

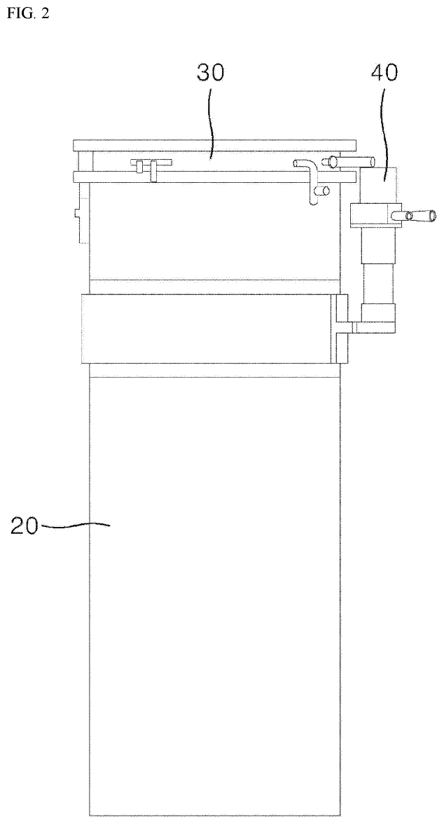

FIG. 1 is a view showing an outer appearance of a superconducting fault current limiter to which a bobbin for winding a superconducting wire rod according to an embodiment of the present disclosure is applied, and FIG. 2 is a view showing a low-temperature container exposed to the outside in a state in which an external vacuum container is removed from a superconducting fault current limiter shown in FIG. 1.

Referring to FIGS. 1 and 2, a superconducting fault current limiter to which an embodiment of the present disclosure is applied includes an external vacuum container 10 and an internal low-temperature container 20. For example, the containers may be formed in a cylindrical shape, and may be formed in a structure in which upper ends thereof may be closed by a cover 30.

In this case, the vacuum container 10 allows an internal environment thereof to be in a vacuum state to maintain thermal isolation from an external environment. In addition, the low-temperature container 20 is accommodated in an inner space of the vacuum container 10, and serves to store a cryogenic fluid such as liquid nitrogen therein.

In addition, a cryogenic freezer 40 is installed on a side of the low-temperature container 20, so that the low-temperature container 20 may maintain an internal environment thereof in a cryogenic state via operation of the cryogenic freezer 40.

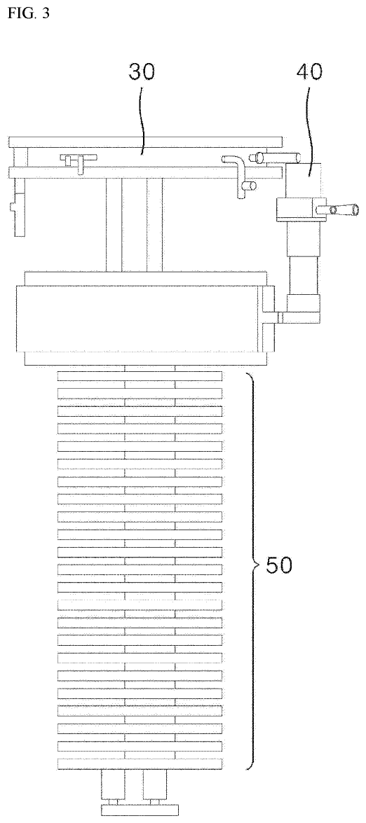

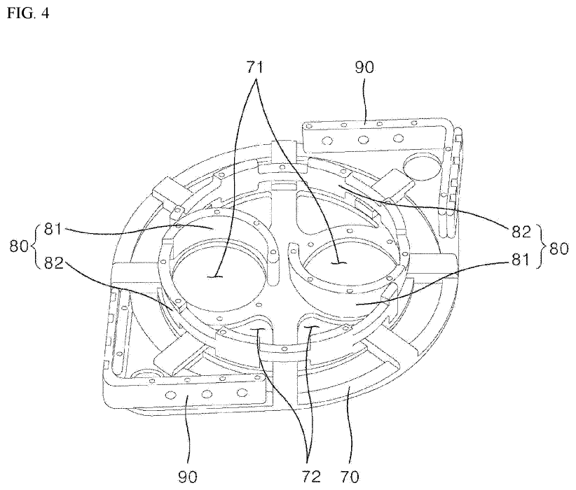

FIG. 3 is a view showing a modular state in which a plurality of bobbins for winding a superconducting wire rod according to an embodiment of the present disclosure are stacked along a vertical direction inside a low-temperature container shown in FIG. 2, and FIG. 4 is for illustrating a bobbin structure for winding a superconducting wire rod according to an embodiment of the present disclosure, and is a perspective view separately showing only one bobbin among the stacked bobbins in the module shown in FIG. 3.

Referring to FIGS. 3 and 4, a superconducting fault current limiting module 50 is constructed by stacking a plurality of bobbins 60 for winding a superconducting wire rod in a vertical direction inside the low-temperature container 20. The bobbin 60 is for winding the superconducting wire rod, and includes a base plate 70 and a protruding structure 80.

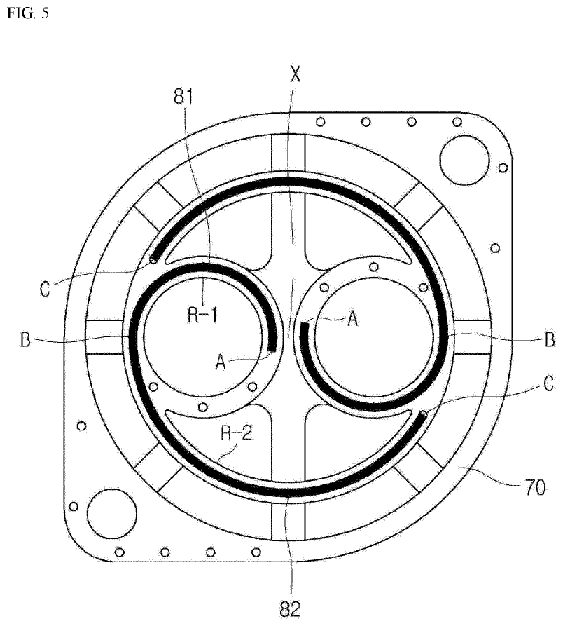

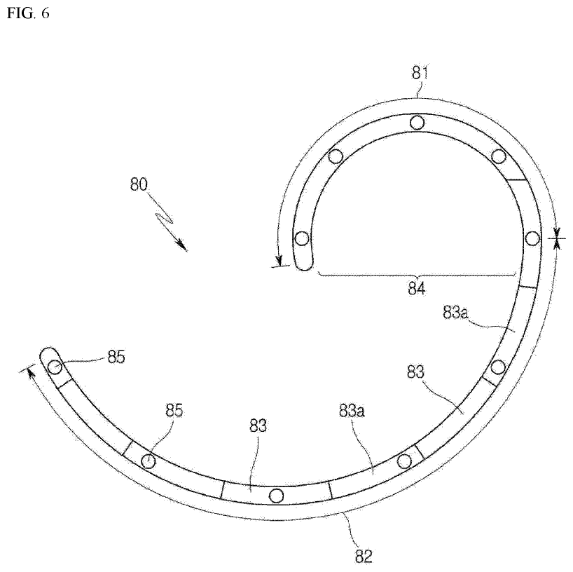

FIG. 5 is for illustrating a bobbin structure for winding a superconducting wire rod according to an embodiment of the present disclosure, and is a plan view separately showing only a base plate from a bobbin shown in FIG. 4, and FIG. 6 is for illustrating a bobbin structure for winding a superconducting wire rod according to an embodiment of the present disclosure, and is a plan view separately showing only a protruding structure from a bobbin shown in FIG. 4.

Referring to FIGS. 5 and 6 together with FIG. 4, the base plates 70 are plate-shaped members and are stacked together with the protruding structures 80 in a layered arrangement structure in the vertical direction inside the low-temperature container 20 for storing the cryogenic fluid. That is, the base plate 70 and the protruding structure 80 are alternately disposed inside the low-temperature container 20, and the superconducting wire rod is installed in a structure of being wound by the appropriate number of times along a circumference of the protruding structure 80.

In addition, the base plate 70 is constructed such that circular openings 71 are defined on left and right sides of a central portion. In this case, the number of circular openings 71 may be unlimited as long as a radial arrangement structure is formed with respect to the central portion of the base plate 70. However, in an embodiment of the present disclosure, for convenience of illustration and description, a description will be made based on a pair of circular openings 71 and a pair of protruding structures 80 disposed on the left and right sides of the central portion of the base plate 70.

In addition, the base plate 70 includes a plurality of through-holes 72 extending through the base plate in a thickness direction and defined around the circular openings 71. In this case, the through-holes 72 serve as a kind of cooling channel capable of allowing the liquid nitrogen, which is the cryogenic fluid, to flow within the low-temperature container 20. That is, an empty space defined by the through-hole 72 corresponds to a kind of vertical passage that allows the cryogenic fluid to flow in the vertical direction.

In addition, it will be more preferable for improving a cooling efficiency that the base plate 70 is constructed such that the circular openings 71 and the through-holes 72 are arranged in a radial structure with respect to a center of the base plate 70.

The protruding structures 80 are a pair of members for winding the superconducting wire rod along the circumferences thereof. The protruding structures 80 are constructed to respectively extend from circumferential portions located at edges of the circular openings 71 on the left and right sides of the central portion of the base plate 70, and bottom surfaces thereof are coupled to the base plate 70.

In addition, the protruding structure 80 is composed of an arc-shaped first extension 81 extending along the circumferential portion of the circular opening 71 from a position adjacent to a central portion X of the base plate 70, and an arc-shaped second extension 82 continuously extending from the first extension 81 along another circumferential portion located radially outward of the circumferential portion of the circular opening 71.

In this case, a curvature of the first extension 81 and a curvature of the second extension 82 are set to be different from each other. More specifically, the curvature of the first extension 81 is set greater than the curvature of the second extension 82. That is, a radius of curvature of the first extension 81 is set smaller than that of the second extension 82.

In addition, the first extension 81 is constructed to extend long over a phase angle of about 180 degrees along a circumferential portion of a first reference circle R-1 set by the circular opening 71 from a starting point A located adjacent to the central portion X of the base plate 70. In particular, in the first extension 81, a connection point B between the first extension 81 and the second extension 82 is located on another second reference circle R-2 on a concentric circle located radially outward of a center of the first reference circle R-1 set by the circular opening 71 with respect to the central portion X of the base plate 70 on the base plate 70.

In addition, the second extension 82 is constructed to extend long over a phase angle of about 180 degrees along a circumferential portion of the second reference circle R-2 from the connection point B between the first extension 81 and the second extension 82. In particular, in the second extension 82, an end point C located at a free end extends long toward a first extension 81 of the other protruding structure 80 located on an opposite side, and is located at a point spaced apart from the first extension 81 of the other protruding structure 80 at a predetermined spacing. That is, the second extension 82 extends long such that a free end of the end point thereof reaches the first extension 81 of the other protruding structure 80 located on the opposite side, and then, is disposed to be spaced apart from the first extension 81 of the other protruding structure 80 at an appropriate spacing.

In summary, the first extension 81 and the second extension 82 constituting the protruding structure 80 extend along the first reference circle R-1 from the starting point A located adjacent to the central portion X of the base plate 70 and continuously extend long from the connection point B along the second reference circle R-2, and are generally constructed to exhibit a form partially similar to an involute curve.

In particular, the first extension 81 is formed curved to have a minimum radius of curvature. In this regard, the radius of curvature of the first extension 81 is set to a minimum level capable of effectively preventing deterioration of mechanical properties and uniformity of an electromagnetic force distribution resulted from shrinkage and expansion acting on the wire rod during quenching of the superconducting wire rod.

That is, the first extension 81 is set to have the minimum radius of curvature capable of preventing the deterioration of the mechanical properties and the uniformity of the electromagnetic force distribution resulted from the shrinkage and the expansion during the quenching of the superconducting wire rod. In addition, the second extension 82 is constructed to have a larger radius of curvature than the first extension 81.

In one example, the protruding structure 80 is constructed as a partition wall structure protruding to have a certain height in the vertical direction with respect to the base plate 70, and has concavo-convex portions 83 and 83a having different protruding heights in the vertical direction on a top surface thereof. In this case, the concave-convex portions 83 and 83a serve as a cooling channel of a kind of horizontal passage capable of allowing a horizontal flow of the liquid nitrogen, which is the cryogenic fluid, in the low-temperature container 20. That is, a space between uppermost and lowermost portions by the concave-convex portions 83 and 83a corresponds to a space such as the cooling channel for the horizontal flow of the cryogenic fluid.

To this end, it will be more preferable for improving the cooling efficiency that there are a plurality of concavo-convex portions 83 and 83a in an alternating arrangement structure over a longitudinal direction on the top surface of the protruding structure 80.

In addition, the protruding structure 80 includes a cutout 84 in a form of partially incising and deleting the structure over a partial section of the circumferential portion of the circular opening 71. In this case, the cutout 84 also serves as the cooling channel of a kind of horizontal passage capable of allowing the horizontal flow of the liquid nitrogen, which is the cryogenic fluid, in the low-temperature container 20.

That is, the cutout 84 is defined over the partial section of the circumferential portion of the circular opening 71, which is located between the first extension 81 and the second extension 82 of the protruding structure 80 and located on a side opposite to the formation position of the first extension 81 with respect to the center of the circular opening 71. The section where the cutout 84 is defined is limited to a section where the superconducting wire rod is not wound.

In addition, the protruding structure 80 has a through-hole 85 for fastening for the vertical stacking of the bobbins 60 inside the low-temperature container 20. It will be preferable that the through-hole 85 for fastening includes a plurality of through-holes for fastening along a longitudinal direction of a member constituting the protruding structure 80.

In one example, the base plate 70 has a pair of end portions 90 protruding in the vertical direction at both left and right ends thereof. Via the end portions 90, a bus bar for electrical connection of the superconducting wire rods respectively wound around the protruding structures 80 of the bobbins 60 stacked in layers is installed.

A scheme in which the superconducting wire rod is wound around the bobbin 60 having the structure as described above in a bifilar form will be described as follows.

First, with a central portion in a longitudinal direction of the superconducting wire rod located at the central portion X of the base plate 70, both sides of the wire rod are wound around the pair of protruding structures 80, respectively.

In this process, one side of the wire rod is wound in a scheme of being wound along an outer surface of the first extension 81 of one protruding structure 80, then, wound along an outer surface of the second extension 82 thereof, and then repeating a path of sequentially passing through a partial section of an outer surface of the first extension 81 of the other protruding structure 80 located on the opposite side and then an entirety of an outer surface of the second extension 82 thereof, and sequentially passing through a partial section of the outer surface of the first extension 81 and an entirety of the outer surface of the second extension 82of said one protruding structure 80 located on the opposite side several times.

In addition, the other side of the wire rod is wound in a scheme of being wound along the outer surfaces of the first extension 81 and the second extension 82 of the other protruding structure 80, and then repeating a path of sequentially passing through the partial section of the outer surface of the first extension 81 and the entirety of the outer surface of the second extension 82 of said one protruding structure 80 located on the opposite side, and sequentially passing through the partial section of the outer surface of the first extension 81 and the entirety of the outer surface of the second extension 82 of the other protruding structure 80 located on the opposite side several times.

When the winding of the superconducting wire rod in the bifilar scheme is completed as such, free ends in the longitudinal direction of the wire rod are located at the left and right sides of the base plate 70, respectively. When the bobbins 60 on which the winding of the superconducting wire rod has been completed are sequentially stacked in the vertical direction, and then, electrical connection of the wire rods in series or parallel is made, fabrication of the superconducting fault current limiting module 50 is completed.

1. A bobbin structure for winding a superconducting wire rod, the bobbin structure comprising:
a base plate stacked inside a low-temperature container for storing low-temperature fluid therein;
a pair of circular openings respectively defined at left and right sides of the base plate; and
a pair of protruding structures respectively extending from circumferential portions of the circular openings on the left and right sides of a central portion of the base plate for the winding of the superconducting wire rod, wherein bottom surfaces of the pair of protruding structures are coupled to the base plate,
wherein each protruding structure includes:
an arc-shaped first extension extending along the circumferential portion of each circular opening from a position adjacent to the central portion of the base plate; and
an arc-shaped second extension extending from the first extension along another circumferential portion located radially outward of the circumferential portion of each circular opening.

2. The bobbin structure of claim 1, wherein the first extension extends long over a phase angle of about 180 degrees along a circumferential portion of a first reference circle set by each circular opening from a starting point located adjacent to the central portion of the base plate,
wherein a connection point between the first extension and the second extension is located on another second reference circle on a concentric circle located radially outward of a center of the first reference circle set by each circular opening with respect to the central portion of the base plate,
wherein the second extension extends long over a phase angle of about 180 degrees along a circumferential portion of the second reference circle from the connection point.

3. The bobbin structure of claim 2, wherein an end point at a free end of a second extension of one protruding structure extends long toward a first extension of the other protruding structure located on an opposite side, and is located at a point spaced apart from the first extension of the other protruding structure by a predetermined spacing.

4. The bobbin structure of claim 1,
wherein the first extension is set to have a minimum radius of curvature capable of preventing deterioration of mechanical properties and uniformity of electromagnetic force distribution resulted from shrinkage and expansion during quenching of the superconducting wire rod,
wherein the second extension is set to have a larger radius of curvature than the first extension.

5. The bobbin structure of claim 4, wherein each protruding structure is constructed as a partition wall structure protruding in a vertical direction with respect to the base plate, and has concavo-convex portions having different protruding heights in the vertical direction on a top surface thereof for defining a cooling channel.

6. The bobbin structure of claim 5, wherein the concavo-convex portions include a plurality of concavo-convex portions as an alternating arrangement structure over a longitudinal direction of each protruding structure.

7. The bobbin structure of claim 1,
wherein each protruding structure includes a cutout over a partial section of the circumferential portion of each circular opening for defining a cooling channel.

8. The bobbin structure of claim 7, wherein the partial section of the circumferential portion of each circular opening where the cutout is defined is located between the first extension and the second extension of each protruding structure and located on a side opposite to a formation position of the first extension with respect to a center of each circular opening.

9. The bobbin structure of claim 1,
wherein each protruding structure has a through-hole for fastening for vertical stacking of the bobbins.

10. The bobbin structure of claim 9, wherein the through-hole for fastening includes a plurality of through-holes for fastening along a longitudinal direction of the protruding structure.

11. The bobbin structure of claim 1,
wherein the base plate includes a plurality of through-holes defined around the circular openings for defining a cooling channel.

12. The bobbin structure of claim 11, wherein the circular openings and the through-holes are arranged in a radial structure with respect to a center of the base plate.

13. The bobbin structure of claim 1, wherein the base plates are stacked in a vertical direction inside the low-temperature container for storing the cryogenic fluid.

14. The bobbin structure of claim 1, wherein circular openings are defined on the left and right sides of the central portion of the base plate.

15. The bobbin structure of claim 1, wherein the second extension includes the arc-shaped second extension extending from the first extension along another circumferential portion located radially outward of the circumferential portion of each circular opening.
